(19) United States
(12) Patent Application Publication
(10) Pub. No.: US 2025/0276736 A1
(43) Pub. Date: Sep. 4, 2025

(54) VEHICLE BASE STRUCTURE

(71) Applicant: TOYOTA JIDOSHA KABUSHIKI KAISHA, Toyota-shi (JP)

(72) Inventors: Toshiaki SATO, Nagakute-shi (JP); Koji Saeki, Okazaki-shi (JP)

(73) Assignee: TOYOTA JIDOSHA KABUSHIKI KAISHA, Toyota-shi (JP)

(21) Appl. No.: 18/973,336

(22) Filed: Dec. 9, 2024

(30) Foreign Application Priority Data
Mar. 1, 2024 (JP) 2024-031632

(51) Int. Cl. B62D 21/15; B62D 21/02

(52) U.S. Cl. CPC B62D 21/155; B62D 21/02

(57) ABSTRACT

On the front side of the motor unit mounted on the suspension member, a front-side mount portion for supporting the front portion of the motor unit is provided on the vehicle lower side relative to the center of gravity G of the motor unit. Further, the rear side of the motor unit, the rear-side mount portion for supporting the rear portion of the motor unit on the left and right of the opposite side and upper side of the front-side mount portion between the center of gravity G of the motor unit is provided, respectively.

### CROSS-REFERENCE TO RELATED APPLICATION

This application claims priority to Japanese Patent Application No. 2024-031632 filed on Mar. 1, 2024, incorporated herein by reference in its entirety.

### BACKGROUND

### 1. Technical Field

The disclosure relates to a vehicle base structure.

### 2. Description of Related Art

Japanese Unexamined Patent Application Publication No. 2020-083144 (JP 2020-083144 A) discloses technology including a motor compartment cross member (hereinafter referred to as “MC cross member”) having a rectangular shape in plan view, for supporting a driving motor. In this related art, a fragile portion which has lower strength than other portions, and which allows entry of a front side member that has bent inward in a vehicle width direction, is provided in a part of an end portion of the MC cross member.

### SUMMARY

On the other hand, when the driving motor is supported by the suspension member, it is difficult to cause the suspension member to stably bend toward a vehicle lower side at the time of a front-side collision of a vehicle (hereinafter, referred to as “time of front collision of the vehicle”) or at the time of a rear-end collision of the vehicle (hereinafter, referred to as “time of rear collision of the vehicle”), i.e., so-called downward convex bending.

Taking the above circumstances into consideration, it is an object of the disclosure to obtain a vehicle base structure capable of stabilizing a bending mode of a suspension member in the event of a collision of a vehicle.

A vehicle base structure according to Aspect 1 includes
a front-side mount portion that is provided on a cross member making up a front portion side of a suspension member and extending in a vehicle width direction, and that is disposed on a vehicle downward side from a center of gravity of a motor unit for driving a vehicle and supports a front portion of the motor unit, and
a rear-side mount portion that is disposed on an opposite side from the front-side mount portion and also on a vehicle upward side, with the center of gravity of the motor unit interposed between, and that supports a rear portion of the motor unit.

The vehicle base structure according to Aspect 1 includes the front-side mount portion that supports the front portion of the motor unit and the rear-side mount portion that supports the rear portion of the motor unit. The front-side mount portion is provided on the cross member that makes up the front portion side of the suspension member and extends in the vehicle width direction, and is disposed on the vehicle downward side from the center of gravity from the motor unit for driving the vehicle. On the other hand, the rear-side mount portion is disposed on the opposite side of the front-side mount portion and also on the vehicle upward side, with the center of gravity of the motor unit interposed therebetween, and supports the rear portion of the motor unit.

In the disclosure, for example, when an impact load is input to the suspension member at the time of a front collision of the vehicle, the impact load is transmitted to the motor unit side via the front-side mount portion. The front-side mount portion is disposed on the vehicle downward side from the center of gravity of the motor unit, and the rear-side mount portion is disposed on the opposite side of the front-side mount portion and also the vehicle upward side with the center of gravity of the motor unit therebetween.

Accordingly, in the disclosure, when an impact load is transmitted to the motor unit, moment toward the vehicle downward side and also a vehicle rearward side acts on the motor unit, about the center of gravity. Thus, in the disclosure, the motor exhibits rotation toward the vehicle downward side and also the vehicle rearward side, and as a result, the suspension member is capable of downward convex bending toward the vehicle downward side.

That is to say, according to the disclosure, downward convex bending of the suspension member by can be aided by utilizing force of the motor unit exhibiting rotation toward the vehicle downward side and the vehicle rearward side, thereby enabling stable downward convex bending of the suspension member.

In other words, according to the disclosure, the bending mode of the suspension member can be controlled. As a result, in the disclosure, an extra reinforcing member or the like for controlling the bending mode of the suspension member can be eliminated, and the weight of the suspension member can be reduced.

With the vehicle base structure according to Aspect 2, in the vehicle base structure according to Aspect 1, the motor unit is disposed at a vehicle front portion. The front-side mount portion is provided at one position at a substantially central portion in the vehicle width direction, and the rear-side mount portion is provided at right and left sides in the vehicle width direction.

In the vehicle base structure according to Aspect 2, the motor unit is disposed at the vehicle front portion. Further, the front-side mount portion is provided at one position at the substantially central portion in the vehicle width direction, and the rear-side mount portion is provided at right and left sides in the vehicle width direction.

As a comparative example, when the front-side mount portion is provided on the left and right sides in the vehicle width direction, the impact load conveyed to the front-side mount portion side is dispersed in the event of a collision of the vehicle. Conversely, in the disclosure, the front-side mount portion is provided at one portion of the substantially central portion in the vehicle width direction, and accordingly the impact load conveyed to the front-side mount portion side can be concentrated at one portion. Thus, according to the disclosure, moment can be applied to the motor unit more effectively than that in the comparative example.

With the vehicle base structure according to Aspect 3, in the vehicle base structure according to Aspect 2, the rear-side mount portion is supported by a cast member integrally molded by die casting.

In the vehicle base structure according to Aspect 3, the rear-side mount portion is supported by the cast member integrally molded by die casting. Accordingly, in the disclosure, the cross member for providing the rear-side mount portion becomes unnecessary in the suspension member, and the weight can be reduced in accordance therewith.

Now, die casting has high strength. Accordingly, in the disclosure, due to the rear-side mount portion being supported by the casting member integrally molded by die casting, the moment can be stably applied to the vehicle downward side and also the vehicle rearward side with respect to the motor unit about the rear-side mount portion. Thus, in the disclosure, downward convex bending of the suspension member can be further aided, and downward convex bending of the suspension member can be caused more stably in the event of a collision of the vehicle.

With the vehicle base structure according to Aspect 4, in the vehicle base structure according to Aspect 1, at a lower portion of a side rail making up part of the suspension member and extending in a vehicle front-rear direction, a first bent portion, that is a starting point for bending of the side rail when the vehicle collides, is provided on a vehicle forward side of the front-side mount portion in side view of the vehicle.

In the vehicle base structure according to Aspect 4, at the lower portion of the side rail making up part of the suspension member and extending in the vehicle front-rear direction, the first bent portion is provided on the vehicle forward side of the front-side mount portion in side view of the vehicle. The first bent portion is the starting point for bending of the side rail when the vehicle collides, with the first bent portion being provided at the lower portion of the side rail, and accordingly at the first bent portion, the side rail is bent toward the vehicle upper side, in so-called upward convex bending.

At the time of collision of the vehicle, the suspension member exhibits downward convex bending toward the vehicle downward side between the front-side mount portion and the rear-side mount portion, under the force of the motor unit exhibiting rotation toward the vehicle downward side and the vehicle rearward side (downward bend portion).

According to the disclosure, by forming an upper convex folding mode on the forward side of the downward convex folding portion, the suspension member can be suppressed from bending along the vehicle width direction, and to the suspension member can be stably bent along a vehicle up-down direction.

With the vehicle base structure according to Aspect 5, in the vehicle base structure according to Aspect 1, at a lower portion of a side rail making up part of the suspension member and extending in a vehicle front-rear direction, a second bent portion, that is a starting point for bending of the side rail when the vehicle collides, is provided on a vehicle rearward side of the rear-side mount portion in side view of the vehicle.

In the vehicle base structure according to Aspect 5, the second bent portion is provided on the vehicle rearward side of the rear-side mount portion in vehicle side view, at the lower portion of the side rail making up part of the suspension member and extending in the vehicle front-rear direction. The second bent portion is the starting point for bending of the side rail when the vehicle collides, with the second bent portion being provided at the lower portion of the side rail, and accordingly at the second bent portion, the side rail exhibits upward convex bending.

In the event of a collision of the vehicle, when the suspension member exhibits downward convex bending toward the vehicle downward side between the front-side mount portion and the rear-side mount portion (downward bent portion), in the disclosure, the upward convex bending mode is formed on the rearward side of this downward convex bending portion. Accordingly, in the disclosure, the suspension member can be suppressed from bending along the vehicle width direction in the event of a collision of the vehicle, and the suspension member can be stably bent along the vehicle up-down direction.

As described above, the vehicle base structure according to the disclosure can stabilize the bending mode of the suspension member in the event of a collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a suspension member and a motor unit, which are part of a vehicle base structure according to an embodiment, viewed from an obliquely front side and an upward side;

FIG. 2A is a comparative example. It is a schematic plan view for explaining a problem of a suspension member;

FIG. 2B is a schematic side view for explaining a modification of a suspension member;

FIG. 3A is a schematic side view illustrating a state immediately before deformation of a suspension member which is a part of a vehicle base structure according to an embodiment; and

FIG. 3B is a schematic side view illustrating a state in which a suspension member, which is a part of a vehicle base structure of the embodiment, is deformed.

### DETAILED DESCRIPTION OF EMBODIMENTS

Hereinafter, a vehicle base structure according to an embodiment will be described with reference to the drawings. In some of the drawings, arrow FR indicates the vehicle front direction, arrow UP indicates the vehicle upper direction, while arrow RH indicates the right-hand side of the vehicle. When the front, rear, right, left, upper and lower directions are mentioned in the following description, these directions refer to the front and rear sides in the vehicle front-rear direction, right and left sides in the vehicle width direction, and upper and lower sides in the up-down direction, respectively, unless otherwise specified.

### Configuration of Vehicle Base Structure

First, a configuration of a vehicle base structure according to the present embodiment will be described.

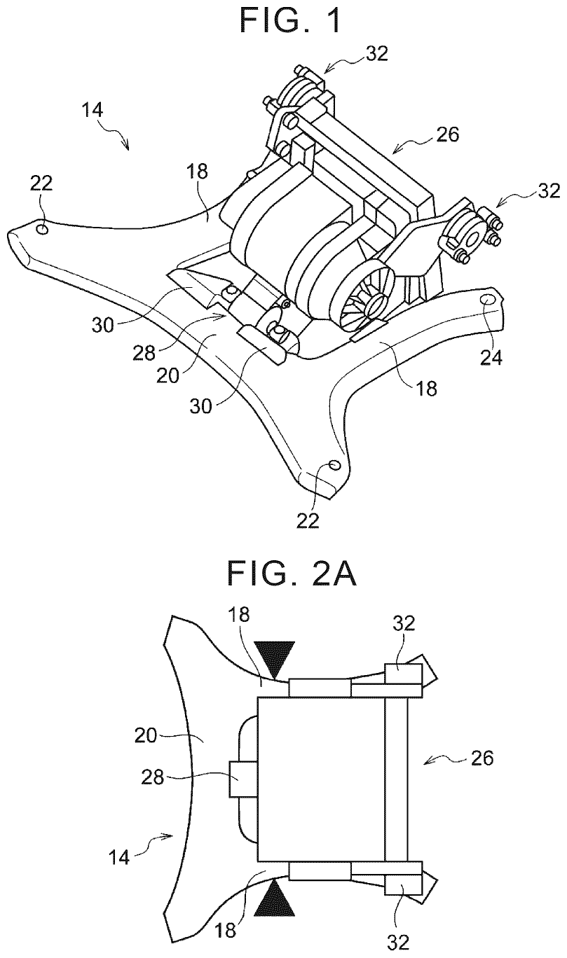

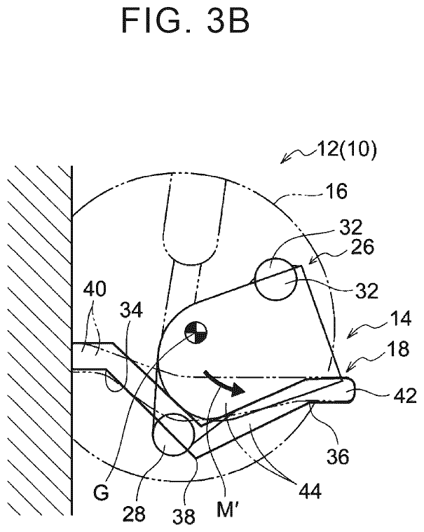

FIGS. 1 and 3A illustrate a suspension member 14 provided in the front portion 12 of the vehicle 10 to which the vehicle base structure according to the present embodiment is applied. The suspension member 14 is fastened to a pair of left and right front side members (not shown) extending in the vehicle front-rear direction at the front portion 12 of the vehicle 10. A pair of left and right wheel houses (not shown) in which the wheels 16 are disposed are provided on both outer sides of the pair of left and right front side members in the vehicle width direction.

For example, in the present embodiment, the pair of left and right front side members and the pair of left and right wheel houses are connected by a cross member (not shown) extending in the vehicle width direction. A pair of left and right front side members, a pair of left and right wheel houses, and the cross member are integrally formed by die casting using an aluminum alloy, a magnesium alloy, or the like as a material.

Here, in the present embodiment, as illustrated in FIG. 1, the suspension member 14 includes a pair of left and right side rails 18 extending in the vehicle front-rear direction at both end portions in the vehicle width direction, and a cross member 20 extending in the vehicle width direction at the front portion 12 of the vehicle 10 and connecting the pair of left and right side rails 18.

Coupling portions 22 and 24 are provided at both end portions in the extending direction of the left and right side rails 18, and can be coupled to the left and right front side members via a mount (not shown) configured to include a damping member such as an anti-vibration rubber, for example. The suspension member 14 is disposed on the lower side of the left and right front side members in a state where the left and right side rails 18 are coupled to the left and right front side members, respectively.

A motor unit 26 can be mounted on the suspension member 14, and the motor unit 26 is disposed between the left and right side rails 18 and is disposed between the left and right front side members.

As shown in FIGS. 1 and 3A, a front-side mount portion 28 is provided on a front side of the motor unit 26 in the motor unit 26. The front-side mount portion 28 is disposed on the vehicle lower side with respect to the center of gravity G of the motor unit 26, and is disposed at one portion of a substantially central portion of the motor unit 26 in the vehicle width direction, and is configured to include a buffer member.

In the present embodiment, the front-side mount portion 28 can be coupled to the rear portion of the cross member 20 of the suspension member 14. A pair of left and right stays 30 are provided at a rear portion of the cross member 20, and the front-side mount portion 28 is coupled via the stays 30. The front portion of the motor unit 26 is supported by the front-side mount portion 28.

On the other hand, a rear-side mount portion 32 is provided on the rear side of the motor unit 26 in the motor unit 26. The rear-side mount portion 32 is disposed on the opposite side and the upper side of the front-side mount portion 28 with the center of gravity G of the motor unit 26 therebetween, and is disposed on both outer sides of the motor unit 26 in the vehicle width direction, and includes a buffer member.

In the present embodiment, the left and right rear-side mount portions 32 are coupled to respective coupled portions provided on the left and right sides of the die casting, although not shown. The rear portions of the motor unit 26 are supported by the left and right rear-side mount portions 32.

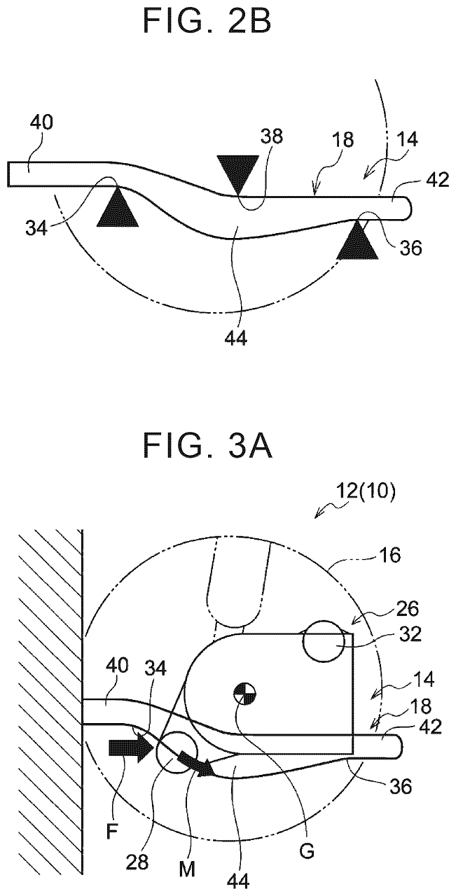

Further, in the present embodiment, as shown in FIGS. 1 and 2B, a bent portion (first bent portion) 34 is provided in the vicinity of the cross member 20 and a bent portion (second bent portion) 36 is provided in the front side of the coupling portion 24 in the lower portion of the left and right side rails 18. In the bent portions 34 and 36, for example, although not shown, a notch is formed, and when the vehicles 10 (refer to FIG. 3B) collide forward, the bent portions are set as the starting points of the bending of the side rails 18.

Further, the side rail 18 is provided with a horizontal portion 40 on the vehicle front side with respect to the bent portion 34, and a horizontal portion 42 is provided on the vehicle rear side with respect to the bent portion 36. The horizontal portion 40 and the horizontal portion 42 are formed along a substantially horizontal direction, and the horizontal portion 42 is disposed below the horizontal portion 40. Between the horizontal portion 40 and the horizontal portion 42, a convex portion 44 formed in a convex shape toward the vehicle lower side is provided.

### Operation and Effects of Vehicle Base Structure

First, the operation and effects of the vehicle base structure according to the present embodiment will be described.

In the present embodiment, as shown in FIGS. 1 and 3A, on the front side of the motor unit 26 mounted on the suspension member 14, a front-side mount portion 28 that supports the front portion of the motor unit 26 is provided on the vehicle-lower side relative to the center of gravity G of the motor unit 26.

Further, the rear side of the motor unit 26, the rear-side mount portion 32 for supporting the rear portion of the motor unit 26 on the left and right opposite and upper side of the front-side mount portion 28 between the center of gravity G of the motor unit 26 is provided, respectively.

In the present embodiment, for example, when an impact load is input to the suspension member 14 at the time of a front collision of the vehicle 10, the impact load F is transmitted to the motor unit 26 side via the front-side mount portion 28. Here, the “front collision” is a concept including not only a front collision of a full lap but also an offset collision, an oblique collision, and a small overlap collision.

As described above, the front-side mount portion 28 is disposed on the vehicle lower side relative to the center of gravity G of the motor unit 26, and the rear-side mount portion 32 is disposed on the vehicle upper side relative to the center of gravity G of the motor unit 26.

Therefore, when the impact load F is transmitted to the motor unit 26, the motor unit 26 exerts a moment M toward the vehicle lower side and the vehicle rear side around the center of gravity G. Thus, in the present embodiment, as shown in FIG. 3B, the motor unit 26 rotates toward the vehicle lower side and the vehicle rear side, so that the side rail 18 of the suspension member 14 can be bent downward toward the vehicle lower side (the lower convex folding portion 38).

That is, in the present embodiment, by using the force that the motor unit 26 tries to rotate toward the vehicle lower side and the vehicle rear side, the downward convex bending of the side rail 18 of the suspension member 14 is promoted, and the side rail 18 can be stably bent downward.

As described above, in the present embodiment, it is possible to stabilize the bending mode of the suspension member 14 when the vehicle 10 collides forward. That is, in the present embodiment, the bending mode of the suspension member 14 can be controlled, and as a result, an extra reinforcing member or the like for controlling the bending mode of the suspension member 14 can be eliminated, and the weight of the suspension member 14 can be reduced.

Further, in the present embodiment, as shown in FIG. 1, the front-side mount portion 28 is provided at a position substantially in the center portion in the vehicle width direction, and the rear-side mount portion 32 is provided on the left and right sides in the vehicle width direction.

For example, as a comparative example, although not shown, when the front-side mount portion 28 is provided on the left and right sides in the vehicle widthwise direction, the impact load F (see FIG. 3A) transmitted to the front-side mount portion 28 side is dispersed when the vehicle 10 collides.

On the other hand, in the present embodiment, since the front-side mount portion 28 is provided at one position in the substantially central portion in the vehicle width direction, the impact load F transmitted to the front-side mount portion 28 side can be concentrated at one position. Therefore, in the present embodiment, a moment can be applied to the motor unit 26 more effectively than in the comparative example.

Further, in the present embodiment, the rear-side mount portion 32 is supported by a cast member integrally molded by die casting. Therefore, in the present embodiment, in the suspension member 14, a cross member for providing the rear-side mount portion 32 is unnecessary, and accordingly, it is possible to reduce the weight.

Now, die casting has high strength. Therefore, in the present embodiment, the rear-side mount portion 32 is supported by the casting member integrally molded by die casting, it is possible to stably apply the moment M′ toward the vehicle lower side and the vehicle rear side with respect to the motor unit 26 around the rear-side mount portion 32.

Therefore, in the present exemplary embodiment, when the vehicle 10 collides, the lower convex folding is further promoted with respect to the side rail 18 of the suspension member 14, so that the suspension member 14 can be more stably lower convex folding.

Further, in the present embodiment, a bent portion 34 is provided in the vicinity of the cross member 20 and a bent portion 36 is provided in the front side of the coupling portion 24 (see FIG. 1) at a lower portion of the left and right side rails 18 of the suspension member 14. The bent portions 34 and 36, for example, although not shown, are formed with notches, and are set as the starting points of the bending of the side rails 18 when an impact load is input.

Since the bent portions 34 and 36 are provided at the lower portion of the side rail 18, the side rail 18 is bent toward the vehicle upper side and is upwardly convex at the bent portion 34 when the vehicle collides.

At the time of collision of the vehicle 10, the suspension member 14 bends downward in the lower convex folding portion 38 toward the vehicle lower side between the front-side mount portion 28 and the rear-side mount portion 32 due to the force that the motor unit 26 tries to rotate toward the vehicle lower side and the vehicle rear side.

In the present embodiment, by forming the upper convex folding mode on the front side of the lower convex folding portion 38, as shown in FIG. 2A, the suspension member 14 is prevented from bending along the vehicle widthwise direction, and as shown in FIG. 2B, the suspension member 14 can be bent along the vehicle up-down direction.

Further, as shown in FIGS. 3A and 3B, in the bent portion 36, similarly to the bent portion 34, the side rail 18 of the suspension member 14 bends toward the vehicle upper side and is upwardly convex.

Therefore, in the present embodiment, as a comparative example, as shown in FIG. 2A, the side rail 18 of the suspension member 14 is prevented from bending along the vehicle widthwise direction, and the suspension member 14 can be bent along the vehicle up-down direction as shown in FIGS. 3A and 3B.

Further, in the present embodiment, the side rail 18 of the suspension member 14 is provided with a horizontal portion 40 on the vehicle front side of the bent portion 34. The horizontal portion 40 is formed along a substantially horizontal direction, and when the impact load F is transmitted to the horizontal portion 40 at the time of the front collision of the vehicle 10, the horizontal portion 40 tends to move toward the vehicle rear side.

As described above, since the direction in which the impact load F is transmitted and the direction in which the horizontal portion 40 is formed are substantially the same, for example, although not shown, the impact load F transmitted to the bent portion 34 side becomes larger in comparison with a case in which an inclined portion inclined in the vehicle up-down direction is provided on the vehicle front side with respect to the bent portion 34 in the side rail 18. Therefore, in the present embodiment, it is possible to easily cause a bend starting from the bent portion 34.

Further, in the present embodiment, the side rail 18 of the suspension member 14 is provided with a horizontal portion 42 on the vehicle rear side of the bent portion 36. The horizontal portion 42 is formed along a substantially horizontal direction. Further, in the side rail 18, between the horizontal portion 40 and the horizontal portion 42, a convex portion 44 formed in a convex shape toward the vehicle lower side is provided.

As described above, since the convex portion 44 is provided in the side rail 18, when the impact load F is transmitted to the side rail 18 at the time of the collision of the vehicle 10, the convex portion 44 is more easily deformed toward the vehicle lower side, and is easily bent downward.

Here, the horizontal portion 42 tends to move to the vehicle front side relatively due to the deformation of the side rail 18. Since the horizontal portion 40 and the horizontal portion 42 are formed along the vehicle front-rear direction, in the present embodiment, the horizontal portions are more effectively moved toward each other as compared with, for example, a case where the horizontal portions are inclined portions inclined in the vehicle up-down direction.

Therefore, in the present embodiment, it is possible to more effectively make the side rail 18 and the lower convex bend easier. At this time, in the side rail 18, it is possible to easily cause the bending starting from the bent portion 36.

### Supplementary Explanation of Embodiment

In the present embodiment, the suspension member 14 provided in the front portion 12 of the vehicle 10 has been described, but it is needless to say that the disclosure may be applied to a suspension member provided in the rear portion of the vehicle 10.

Further, in the present embodiment, the rear-side mount portion 32 is supported by the cast member integrally molded by die casting, the center of gravity G of the motor unit 26 since it is only necessary to be disposed on the opposite side and the vehicle upper side of the front-side mount portion 28 between.

For example, in the present embodiment, the front side member, the pair of left and right wheel houses and the cross member are integrally molded by die casting, these are not necessarily integrally molded by die casting, these members may be formed as separate bodies. In this case, for example, the rear-side mount portion 32 may be coupled to the front side member.

Further, in the present embodiment, the front-side mount portion 28 is provided at a position substantially in the center portion in the vehicle width direction, and the rear-side mount portion 32 is provided on the left and right sides in the vehicle width direction, but the disclosure is not limited thereto.

Further, in the present embodiment, the front side member, the pair of left and right wheel houses and the cross member are integrally molded by die casting, but the disclosure is not limited thereto. For example, it may be integrally molded of a plastic such as CFRP.

Furthermore, in the present embodiment, the bent portions 34 and 36 are provided in the lower portions of the left and right side rails 18, respectively, but the bent portions 34 and 36 are not necessarily required, and either one of the bent portions 34 and 36 may be formed.

While an embodiment of the disclosure has been described above, the disclosure is not limited to such an embodiment, and it is needless to say that one embodiment and various modifications may be appropriately combined and used, or that the disclosure may be implemented in various forms without departing from the gist of the disclosure.

### Additional Remarks

Note that the vehicle base structure according to the disclosure may be formed by appropriately combining the following configurations.

### Configuration 1

In the vehicle base structure, a front-side mount portion is provided on a cross member which constitutes a front side of a suspension member and extends in a vehicle width direction, and is arranged on a vehicle lower side than a center of gravity of a motor unit for driving the vehicle, and supports a front portion of the motor unit, and a rear-side mount portion which is arranged on an opposite side of the front-side mount portion and an upper side of the vehicle with a center of gravity of the motor unit interposed therebetween, and supports a rear portion of the motor unit.

### Configuration 2

The motor unit is disposed at a front portion of the vehicle, the front-side mount portion is provided at a substantially central portion in the vehicle width direction, and the rear-side mount portion is provided at the left and right in the vehicle width direction.

### Configuration 3

The rear-side mount portion is supported by a cast member integrally molded by die casting.

### Configuration 4

In a lower portion of a side rail constituting a part of the suspension member and extending in the vehicle front-rear direction, a first bent portion is provided on a vehicle front side of the front-side mount portion in a vehicle side view, which is a starting point of bending of the side rail when the vehicle collides.

### Configuration 5

In a lower portion of the side rail constituting a part of the suspension member and extending in the vehicle front-rear direction, a second bent portion is provided on a vehicle rear side of the rear-side mount portion in a vehicle side view, which is a starting point of bending of the side rail when the vehicle collides.

What is claimed is:

1. A vehicle base structure, comprising:
a front-side mount portion that is provided on a cross member making up a front portion side of a suspension member and extending in a vehicle width direction, and that is disposed on a vehicle downward side from a center of gravity of a motor unit for driving a vehicle and supports a front portion of the motor unit; and
a rear-side mount portion that is disposed on an opposite side from the front-side mount portion and also on a vehicle upward side, with the center of gravity of the motor unit interposed between, and that supports a rear portion of the motor unit.

2. The vehicle base structure according to claim 1, wherein
the motor unit is disposed at a vehicle front portion, and
the front-side mount portion is provided at one position at a substantially central portion in the vehicle width direction, and the rear-side mount portion is provided at right and left sides in the vehicle width direction.

3. The vehicle base structure according to claim 2, wherein the rear-side mount portion is supported by a cast member integrally molded by die casting.

4. The vehicle base structure according to claim 1, wherein, at a lower portion of a side rail making up part of the suspension member and extending in a vehicle front-rear direction, a first bent portion, that is a starting point for bending of the side rail when the vehicle collides, is provided on a vehicle forward side of the front-side mount portion in side view of the vehicle.

5. The vehicle base structure according to claim 1, wherein, at a lower portion of a side rail making up part of the suspension member and extending in a vehicle front-rear direction, a second bent portion, that is a starting point for bending of the side rail when the vehicle collides, is provided on a vehicle rearward side of the rear-side mount portion in side view of the vehicle.
